(19) United States
(12) Patent Application Publication
(10) Pub. No.: US 2026/0027884 A1
(43) Pub. Date: Jan. 29, 2026

(54) VEHICLE BOTTOM STRUCTURE

(71) Applicant: TOYOTA JIDOSHA KABUSHIKI KAISHA, Toyota-shi (JP)

(72) Inventors: Fumio Nomizo, Toyota-shi (JP); Katsunori Higashihara, Toyota-shi (JP); Kazuki Funahashi, Nagoya-shi (JP); Yuuji Mizutani, Toyota-shi (JP)

(73) Assignee: TOYOTA JIDOSHA KABUSHIKI KAISHA, Toyota-shi (JP)

(21) Appl. No.: 19/076,152

(22) Filed: Mar. 11, 2025

(30) Foreign Application Priority Data
Jul. 26, 2024 (JP) 2024-120981

(51) Int. Cl. B60K 1/04; B62D 21/02; B62D 27/06

(52) U.S. Cl. CPC B60K 1/04; B62D 21/02; B62D 27/06; B60K 2001/0438

(57) ABSTRACT

The vehicle bottom structure includes a battery pack and a plurality of outer cross members. On the lower surface of the lower wall of each outer cross member, an upper reinforcing member having a dish-shaped cross section that opens downward is disposed. A share panel having a projection in contact with a lower surface of each of the upper reinforcing members is disposed below the plurality of upper reinforcing members. A lower reinforcing member is disposed inside each projection of the share panel. The lower reinforcing member, the share panel, the upper reinforcing member, and the lower wall of the outer cross member are superposed and fastened by bolts. Both ends of the lower surface of the upper reinforcing member in the vehicle front-rear direction are located outward of both ends of the lower wall of the outer cross member in the vehicle front-rear direction.

### CROSS-REFERENCE TO RELATED APPLICATION

This application claims priority to Japanese Patent Application No. 2024-120981 filed on Jul. 26, 2024. The disclosure of the above-identified application, including the specification, drawings, and claims, is incorporated by reference herein in its entirety.

### BACKGROUND

### 1. Technical Field

The present disclosure relates to a bottom structure of an electrified vehicle in which a battery pack is mounted below a floor.

### 2. Description of Related Art

Electrified vehicles such as battery electric vehicles (BEVs) are known. An electrified vehicle includes a battery pack that supplies electric power to a travel motor. The battery pack is mounted below the floor of a vehicle cabin.

Japanese Unexamined Patent Application Publication No. 2023-87250 (JP 2023-87250 A) discloses a battery case that is mounted under the floor of a vehicle cabin of a battery electric vehicle and in which a battery is stored.

### SUMMARY

An electrified vehicle includes a battery pack mounted below the floor. The electrified vehicle includes a plurality of outer cross members disposed below the battery pack at intervals in the vehicle front-rear direction. The electrified vehicle includes a share panel disposed below the outer cross members to cover the battery pack from below. The share panel forms a vehicle bottom surface below the floor.

The battery pack has a case that houses a battery module. Each of the outer cross members has a hat-shaped cross section open upward, extends in the vehicle width direction, and is attached to the outer surface of a bottom plate of the case of the battery pack. A lower wall (web) of each of the outer cross members and the share panel are stacked and fastened by bolts. That is, the share panel is held by the outer cross members at intervals in the vehicle front-rear direction.

When an object collides with the share panel from the vehicle lower side, the share panel deflects upward between two fastening points (fastening points with two outer cross members) of the share panel in the vehicle front-rear direction. This may cause the share panel to approach the battery pack and damage the battery pack. It is desired to reduce the amount of upward deflection of the share panel when an object collides with the share panel from the vehicle lower side.

The present disclosure provides a vehicle bottom structure capable of reducing upward deflection of a share panel when an object collides with the share panel from the vehicle lower side.

A vehicle bottom structure of the present disclosure includes: a battery pack including a case that houses a battery module inside, the battery pack being mounted below a floor; and a plurality of outer cross members located below a bottom plate of the case and disposed at intervals in a vehicle front-rear direction.

Each of the outer cross members has a hat-shaped cross section open upward, extends in a vehicle width direction, and is attached to an outer surface of the bottom plate of the case.

An upper reinforcing member having a dish-shaped cross section open downward and extending in the vehicle width direction is disposed on a lower surface of a lower wall of each of the outer cross members.

A share panel that covers the bottom plate of the case is disposed below a plurality of the upper reinforcing members.

The share panel includes a projection located at a position corresponding to each of the upper reinforcing members and bent in contact with a lower surface of each of the upper reinforcing members.

A lower reinforcing member extending in the vehicle width direction is disposed inward of each of the projections of the share panel.

The lower reinforcing members, the share panel, the upper reinforcing members, and the lower walls of the outer cross members are stacked and fastened by bolts at intervals in the vehicle width direction.

Both ends of the lower surface of the upper reinforcing member in the vehicle front-rear direction are located outward of both ends of the lower wall of the outer cross member in the vehicle front-rear direction.

In the above configuration, the distance between the fulcrums of bending moment of the share panel when an object collides with the share panel from the vehicle lower side is shorter than the distance in a case where the share panel is directly fastened to the lower wall of the outer cross member. That is, the distance between the fulcrums of the bending moment of the share panel is shortened by each upper reinforcing member whose both ends in the vehicle front-rear direction are located outward of those of the outer cross member. Thus, it is possible to reduce the upward deflection of the share panel.

In the above configuration, the share panel is sandwiched between the upper reinforcing member and the lower reinforcing member. Therefore, when an object collides with the share panel from the vehicle lower side, it is possible to restrict movement of the share panel toward the colliding object relative to the two reinforcing members (upper reinforcing member and lower reinforcing member). Thus, it is possible to reduce the upward deflection of the share panel.

In the vehicle bottom structure of the present disclosure, the bolt includes a head located on a lower surface of the lower reinforcing member, and is fastened to a nut disposed on an upper surface of the lower wall of the outer cross member, and the lower surface of the lower reinforcing member includes a recess that at least part of the head of the bolt enters.

In this configuration, it is possible to reduce the amount of protrusion of the head of the bolt from the vehicle bottom surface. Alternatively, it is possible to prevent the protrusion of the head of the bolt from the vehicle bottom surface. Thus, it is possible to expect improvement in aerodynamic performance of the vehicle.

According to the technology of the present disclosure, it is possible to reduce the upward deflection of the share panel when an object collides with the share panel from the vehicle lower side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an upper surface of a share panel of a vehicle according to an embodiment;

FIG. 2 is a cross-sectional view taken along II-II line of FIG. 1;

FIG. 3 is a cross-sectional view showing the bolt regions of the upper reinforcing members and the lower reinforcing members in another embodiment; and

FIG. 4 is a cross-sectional view illustrating the non-bolted regions of the upper reinforcing members and the lower reinforcing members in another embodiment.

### DETAILED DESCRIPTION OF EMBODIMENTS

Hereinafter, embodiments will be described with reference to the drawings. In all the drawings, equivalent elements are denoted by the same reference numerals, and redundant description is omitted. In the following description, unless otherwise specified, the terms indicating the front-rear, right-left, and up-down, etc. directions indicate the directions related to a vehicle. In the drawings, the direction of the arrow FR indicates the front side, the direction of the arrow UP indicates the upper side, and the direction of the arrow RH indicates the right side.

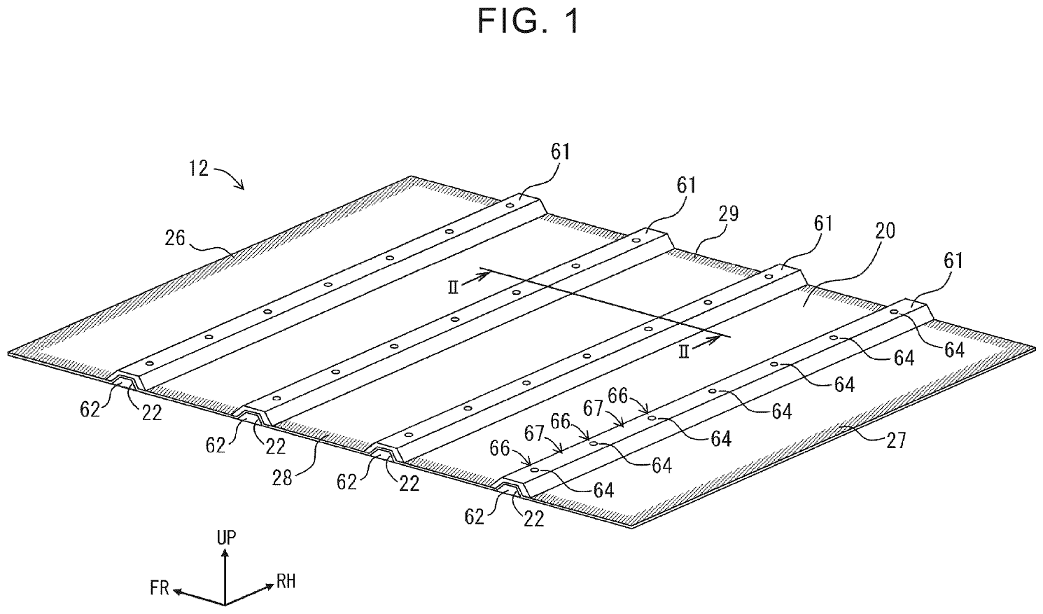

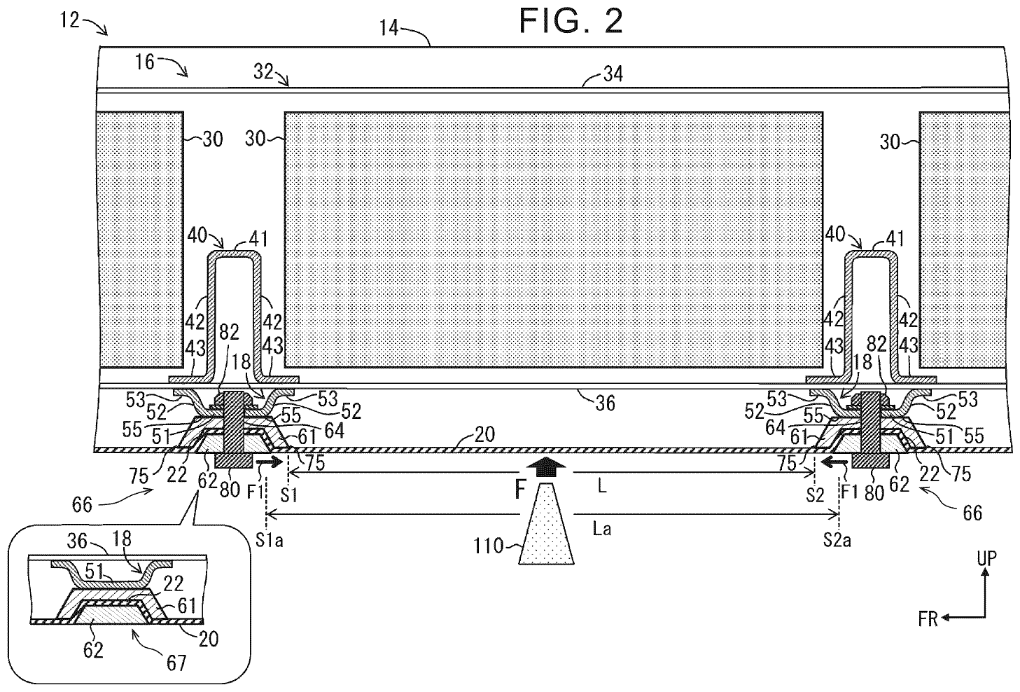

FIG. 1 is a perspective view schematically illustrating an upper surface of a share panel 20 of a vehicle 12. FIG. 2 is a cross-sectional view taken along II-II of FIG. 1 and also shows the battery pack 16 and the floor 14 located above the share panel 20. The vehicles 12 are electrified vehicle such as battery electric vehicle, hybrid battery electric vehicle, and plug-in hybrid battery electric vehicle. Electrified vehicle includes a battery pack 16 that supplies electric power to a motor (not shown) serving as a power source.

As shown in FIG. 2, the battery pack 16 is mounted below the floor 14 of the vehicle cabin. The vehicle 12 includes a share panel 20 that covers the battery pack 16 from below. The share panel 20 forms a vehicle bottom surface below the floor 14.

The battery pack 16 includes a plurality of battery modules 30 and a case 32. The battery module 30 includes a battery stack in which a plurality of battery cells are stacked. The case 32 is an outer shell of the battery pack 16. The case 32 houses a plurality of battery modules 30 therein. The case 32 includes a lower case and an upper case. The lower case has, for example, a bathtub shape, and the upper case has, for example, an inverted bathtub shape (a shape in which the bathtub is inverted). An upper case is fixed on the lower case. FIG. 2 shows the bottom plate 36 of the lower case and the top plate 34 of the upper case.

A plurality of inner cross members 40 are attached to the upper surface of the bottom plate 36 of the case 32. The inner cross member 40 is disposed in a gap between the adjacent battery modules 30 and extends in the vehicle width direction (vehicle left-right direction). The inner cross member 40 is a folded plate member having a hat-shaped cross section. The inner cross member 40 includes a web 41, a pair of flanges 42 erected at both ends of the web 41, and a pair of arms 43 extending outward from the tips of the pair of flanges 42. The arm 43 of the inner cross member 40 is joined to the upper surface of the bottom plate 36.

The vehicle 12 includes a plurality of outer cross members 18. The plurality of outer cross members 18 are located below the bottom plate 36 of the case 32 and are spaced apart from each other in the vehicle front-rear direction. The outer cross member 18 has a hat-shaped cross section opened upward and extends in the vehicle width direction. The outer cross member 18 is a folded plate member. The outer cross member 18 includes a lower wall 51 (web), a pair of flanges 52 erected on both side ends of the lower wall 51, and a pair of arms 53 extending outward from the tips of the pair of flanges 52. The arm 53 of the outer cross member 18 is joined to the lower surface of the portion of the bottom plate 36 to which the arm 43 of the inner cross member 40 is joined. A weld nut 82 is welded to the inside of the outer cross member 18.

The vehicle 12 includes a plurality of upper reinforcing members 61. The upper reinforcing member 61 is an elongated member having a dish-shaped cross section (concave cross section) opening downward and extending in the vehicle width direction. The upper reinforcing member 61 has a shape extending in the vehicle front-rear direction (the lateral direction of the upper reinforcing member 61) from the upper portion toward the lower portion. The upper reinforcing member 61 may be, for example, an extruded metal material, a steel material, a resin material, or the like. The upper reinforcing member 61 is disposed on the lower surface of the lower wall 51 of each outer cross member 18. As shown in FIG. 1, the upper reinforcing member 61 is disposed on the share panel 20 at intervals in the vehicle front-rear direction. Each upper reinforcing member 61 extends from the left end 28 to the right end 29 of the share panel 20. Note that each of the upper reinforcing members 61 may be disposed only in a region inside the left end 28 and the right end 29 of the share panel 20 in the vehicle width direction.

The share panel 20 is a bottom plate of a vehicle, and has a substantially rectangular shape whose longitudinal direction is the vehicle front-rear direction in a plan view. The share panel 20 may be made of, for example, an aluminum material, a high-tensile material (steel material having high tensile strength), or the like. The share panel 20 is located below the plurality of upper reinforcing members 61 and covers the bottom plate 36 of the case 32 of the battery pack 16. The share panel 20 is bent so as to be in contact with the lower surface of each of the upper reinforcing members 61, and has a hollow projection 22 (protruding portion) at a position corresponding to each of the upper reinforcing members 61. The projection 22 has a shape extending in the vehicle front-rear direction from the upper portion toward the lower portion.

As shown in FIG. 1, the share panel 20 includes a front end 26, a rear end 27, a left end 28, and a right end 29. Although not shown, the front end 26, the rear end 27, the left end 28, and the right end 29 are machined into a desired shape so as to be attachable to a skeletal member of a vehicle. The front end 26, the rear end 27, the left end 28, and the right end 29 of the share panel 20 are respectively attached to the skeleton members of the front portion of the vehicle body, the rear portion of the vehicle body, the left portion of the vehicle body, and the right portion of the vehicle body.

The vehicle 12 includes a plurality of lower reinforcing members 62. The lower reinforcing member 62 is an elongated member having a solid trapezoidal cross section and extending in the vehicle width direction. The lower reinforcing member 62 has a shape extending in the vehicle front-rear direction (the lateral direction of the lower reinforcing member 62) from the upper portion toward the lower portion. The lower reinforcing member 62 may be, for example, an extruded metal material, a steel material, a resin material, or the like. The lower reinforcing member 62 is disposed inside each projection 22 of the share panel 20. Note that the lower surface of the lower reinforcing member 62 may be configured to be flush with the lower surface adjacent to the projection 22 of the share panel 20. As shown in FIG. 1, each lower reinforcing member 62 extends from the left end 28 to the right end 29 of the share panel 20. Note that each of the lower reinforcing members 62 may be disposed only in a region inside the left end 28 and the right end 29 of the share panel 20 in the vehicle width direction.

As shown in FIG. 1, in the share panel 20, the projections 22 are sandwiched between the lower reinforcing member 62 and the upper reinforcing member 61 at intervals in the vehicle front-rear direction.

The upper reinforcing member 61 and the lower reinforcing member 62 (hereinafter, referred to as upper/lower reinforcing members 61 and 62) are provided with a plurality of bolt through holes spaced apart in the vehicle width direction. In FIG. 1, a bolt through hole 64 of the upper reinforcing member 61 is shown. A bolt 80 (see FIG. 2) inserted from below the lower reinforcing member 62 is passed through each bolt through-hole of the upper/lower reinforcing members 61 and 62. Hereinafter, a region in which the bolt through-holes of the upper/lower reinforcing members 61 and 62 are provided is referred to as a bolt region 66 (see FIG. 1). Further, a region between adjacent bolt through holes of the upper/lower reinforcing members 61 and 62 is referred to as a non-bolt region 67. II-II cross-section of FIG. 2 shows the bolt regions 66 of the two sets of upper/lower reinforcing members 61, 62, and the blowout of the figure shows the non-bolt regions 67 of one set of upper/lower reinforcing members 61, 62.

As shown in FIG. 2, the lower reinforcing member 62, the projection 22 of the share panel 20, the upper reinforcing member 61, and the lower wall 51 of the outer cross member 18 are stacked and fastened by bolts 80. The bolt 80 passes through the bolt through-hole of the lower reinforcing member 62 and passes through the share panel 20. The bolt 80 passes through the bolt through hole 64 of the upper reinforcing member 61 and passes through the lower wall 51 of the outer cross member 18. The bolt 80 is fastened to the weld nut 82 of the outer cross member 18. The upper/lower reinforcing members 61 and 62 are provided with fastening points (bolt regions 66) by the bolt 80 and the nut 82 side by side at intervals in the vehicle width direction.

As shown in FIG. 2, in each of the plurality of upper reinforcing members 61, both ends 75 in the vehicle front-rear direction on the lower surface of the upper reinforcing member 61 are located outward from both ends 55 in the vehicle front-rear direction of the lower wall 51 of the outer cross member 18.

According to the embodiment described above, as shown in FIG. 2, when the object 110 on the road surface collides with the share panel 20 and the collision load F is input to the share panel 20, the upward deflection of the share panel 20 can be reduced. That is, the share panel 20 is directly fastened to the lower wall 51 of each outer cross member 18. In this case, the distance La between the rear end 55 of the front outer cross member 18 and the front end 55 of the rear outer cross member 18 is the distance between the fulcrums of the bending moment of the share panel 20 at the time of the object collision. The rear end 55 of the front outer cross member 18 is indicated by the reference Sla in FIG. 2. The front end 55 of the rear outer cross member 18 is indicated by the reference S2a in FIG. 2.

On the other hand, according to the embodiment described above, the upper reinforcing member 61 is disposed between the share panel 20 and the lower wall 51 of the outer cross member 18. Both ends 75 of the lower surface of the upper reinforcing member 61 in the vehicle front-rear direction are located outward of both ends 55 of the lower wall 51 of the outer cross member 18 in the vehicle front-rear direction. Therefore, the distance between the rear end 75 (reference numeral S1 in FIG. 2) of the front upper reinforcing member 61 and the front end 75 (reference numeral S2) of the rear upper reinforcing member 61 is the distance L between the fulcrums of the bending moment of the share panel 20 at the time of an object collision. In this case, the distance L between the fulcrums of the bending moment is shorter than that in the case where the share panel 20 is directly fastened to the outer cross member 18 (L<La). Therefore, when the object 110 collides with the share panel 20, the upward deflection of the share panel 20 can be reduced.

Further, according to the embodiment described above, the share panel 20 is sandwiched between the upper reinforcing member 61 and the lower reinforcing member 62. When the object 110 collides with the share panel 20 from the lower side of the vehicle, as shown by the arrow μl in FIG. 2, a force is generated to move the share panel 20 from the upper/lower reinforcing members 61 and 62. That is, the share panel 20 attempts to move toward the colliding object 110. However, according to the embodiment described above, since the share panel 20 is sandwiched between the upper reinforcing member 61 and the lower reinforcing member 62, it is possible to restrict the movement of the share panel 20 with respect to the upper/lower reinforcing members 61 and 62. Therefore, the upward deflection of the share panel 20 can be reduced.

Further, according to the embodiment described above, it is not necessary to adhere or bond the upper reinforcing member 61 to the outer cross member 18 and the share panel 20. Similarly, the lower reinforcing member 62 does not need to be bonded or bonded to the share panel 20. Therefore, the upper/lower reinforcing members 61 and 62 can be relatively easily incorporated into the vehicle 12.

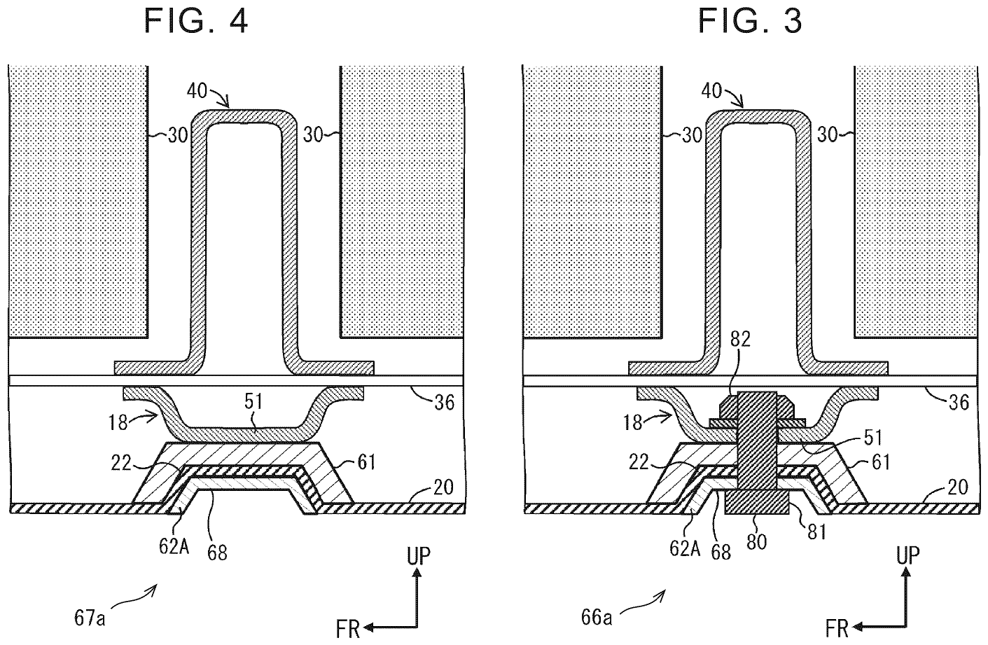

Next, another embodiment will be described. FIG. 3 is a cross-sectional view showing the upper/lower reinforcing member 61 and 62A bolt area 66a in this alternative embodiment. FIG. 4 is a cross-sectional view showing the upper/lower reinforcing member 61 and 62A non-bolted regions 67a in this alternative embodiment. In this embodiment, the lower surface of the lower reinforcing member 62A has a recess 68 into which all of the head 81 of the bolt 80 enters. That is, like the upper reinforcing member 61, the lower reinforcing member 62A has a dish-shaped cross section (concave cross section) that opens downward and extends in the vehicle-width-direction. The head 81 of the bolt 80 is located on the lower surface of the recess 68 of the lower reinforcing member 62A. Other configurations are the same as those of the embodiment described with reference to FIGS. 1 and 2.

According to this embodiment, since the head 81 of the bolt 80 does not protrude from the vehicle bottom surface, it is possible to expect an improvement in aerodynamic performance of the vehicle. Note that the lower surface of the lower reinforcing member 62A may have a recess 68 in which only a part of the head 81 of the bolt 80 enters the inside.

What is claimed is:

1. A vehicle bottom structure comprising:
a battery pack including a case that houses a battery module inside, the battery pack being mounted below a floor; and
a plurality of outer cross members located below a bottom plate of the case and disposed at intervals in a vehicle front-rear direction, wherein
each of the outer cross members has a hat-shaped cross section open upward, extends in a vehicle width direction, and is attached to an outer surface of the bottom plate of the case,
an upper reinforcing member having a dish-shaped cross section open downward and extending in the vehicle width direction is disposed on a lower surface of a lower wall of each of the outer cross members,
a share panel that covers the bottom plate of the case is disposed below a plurality of the upper reinforcing members,
the share panel includes a projection located at a position corresponding to each of the upper reinforcing members and bent in contact with a lower surface of each of the upper reinforcing members,
a lower reinforcing member extending in the vehicle width direction is disposed inward of each of the projections of the share panel,
the lower reinforcing members, the share panel, the upper reinforcing members, and the lower walls of the outer cross members are stacked and fastened by bolts at intervals in the vehicle width direction, and
both ends of the lower surface of the upper reinforcing member in the vehicle front-rear direction are located outward of both ends of the lower wall of the outer cross member in the vehicle front-rear direction.

2. The vehicle bottom structure according to claim 1, wherein:
the bolt includes a head located on a lower surface of the lower reinforcing member, and is fastened to a nut disposed on an upper surface of the lower wall of the outer cross member; and
the lower surface of the lower reinforcing member includes a recess that at least part of the head of the bolt enters.
